(19) United States
(12) Patent Application Publication
(10) Pub. No.: US 2015/0354179 A1
(43) Pub. Date: Dec. 10, 2015

(54) MANIFOLD HEAD FOR A FLUID CONDITIONING COLUMN

(71) Applicant: WALKER FILTRATION LTD, Tyne & Wear (GB)

(72) Inventor: Brian WALKER, Hexham (GB)

(21) Appl. No.: 14/675,971

(22) Filed: Apr. 1, 2015

(30) Foreign Application Priority Data
Jun. 4, 2014 (GB) 1409903.0

(51) Int. Cl. E03B 7/07; B01D 35/02; B01D 35/30; B01D 29/52

(52) U.S. Cl. CPC E03B 7/07; B01D 29/52; B01D 35/02; B01D 35/30

(57) ABSTRACT

A manifold head is provided for a column in which fluid is conditioned by flow through a conditioning component, the column including the manifold head and an elongate container for the conditioning component, in use the manifold head being sealingly assembled to an end of the container. The manifold head has an external wall, an inlet port for incoming flow of fluid into the column, an outlet port for outgoing flow of fluid out of the column, and an internal flow guidance formation for guiding the incoming flow to the conditioning component and for guiding the outgoing flow from the conditioning component. The flow guidance formation further maintains separation of the incoming and outgoing flows within the column en route to and from the conditioning component. The external wall and the internal flow guidance formation of the manifold head are constituent parts of a unitary extruded body section.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a manifold head for a fluid conditioning column.

2. Description of Related Art Including Information Disclosed Under 37 CFR 1.97 and 37 CFR 1.98.

Most in-line filter columns for liquids and gases use a two-piece column having a manifold head for connecting to the process inlet and outlet pipe work, and an elongate container, typically in the form of a tubular filter bowl, containing the filtering component. Inlet and outlet ports of the manifold head are normally opposite each other and coaxial. The fluid flows into the manifold through the inlet port, through the filtering component and then out through the outlet port.

The filtering component is typically material of tubular shape extending into the filter bowl and is of a smaller diameter than the internal diameter of the filter bowl, thereby forming an annular gap for fluid to flow freely along the length of the filtering material and to or from the surface thereof. The fluid flow can be either be inwardly or outwardly directed through the filtering material.

Filter components are multi-various, but can include: water separation devices, particulate and coalescing cartridges, sorbent cartridges and columns, membranes in pleated, wrapped and tubular bundles or any combination thereof. Indeed, filter columns are just an example of a more general class of fluid conditioning columns. The conditioning components of such columns can be cyclonic separators, fluid heaters, fluid coolers etc.

In order for the manifold head of such a column to operate effectively, the manifold may have an internal flow guidance formation, usually with a 90° elbow arrangement, which directs the flow centrally into or out of the conditioning component en route from or to one of the ports. Surrounding a portion of the flow guidance formation a, typically kidney-shaped, slot connects with the other one of the ports thus allowing the free passage of fluid from or to the annular gap at the outside of the conditioning component.

For example FIG. 1 is a front view partly in vertical section of a filter column 2 of known type which includes a filter bowl 8, a manifold head 6 sealingly assembled to the bowl 2, and a bottom end cap 10, the bowl 2 containing a filter element 4 and a condensate drain 12. The filter element 4 includes a conventional body 14 of annular configuration, and a top end cap 16.

The manifold 6 includes an inlet port 18 that feeds into a conduit extent 20 formed within the manifold 6 and which terminates in a cylindrical sealing surface 22 within the manifold 6. The manifold 6 also includes an outlet port 24 axially aligned with the inlet port 18.

The end cap 16 of the filter element 4 includes a second conduit extent 26 of circular transverse section feeding centrally therefrom and terminating in an annular rim 28 having O-ring seals which mate with the sealing surface 22 within the manifold 6. In this way, the first and second conduit extents 20, 26 combine to constitute an elbow shaped conduit interconnecting the inlet port 18 with the hollow interior of the annular body 14 of the filter element 4.

In use, fluid to be filtered, for example gas containing contaminants in aerosol, liquid or solid particulate form, is fed to the inlet port 18 and flows through the column 2 as shown by the arrows in FIG. 1. The fluid flows through the elbow shaped conduit formed by the extents 20, 26 and into the hollow interior of the filter element 4. The fluid passes through the material of the body 14 and into the annular volume between the filter element 4 and the filter bowl 8. It then passes through a kidney-shaped slot 30 formed in the manifold head 6 around the sealing surface 22, and exits the column as clean fluid through the outlet port 24.

The condensate drain 12 ensures that bulk liquid contamination removed from a gas stream can be readily removed from the column. The direction of flow of the fluid through the column could be reversed if considered beneficial under particular circumstances.

Conventional manifolds are usually cast in metal, although some are injection moulded in plastic or machined from solid bar stock.

A problem with metal castings is porosity, which may not be detected until additional and costly post-processing, such as machine work, has been carried out. Macro porosity can usually be seen by the naked eye, but more common is micro porosity which can only be detected by further processes such bubble testing with compressed air or ultrasonic testing, both of which add cost to the manufacturing process. Furthermore, additional costs can also be incurred should corrective post-treatments such as resin impregnation be required to rectify this porosity.

A further problem with castings when used for pressure purposes is that additional material may be required under pressure vessel rules to take into account the inherent variation in components produced by the casting method. These rules may also stipulate the types of material which can be used. As the rules can vary from country to country, they raise another problem of identifying casting vendors capable of manufacturing to the required material standards.

It would be desirable to provide a manifold head for a fluid conditioning column that overcomes or mitigates these problems.

### BRIEF SUMMARY OF THE INVENTION

Accordingly, in a first aspect, the present invention provides a manifold head for a column in which fluid is conditioned by flow through a conditioning component, the column including the manifold head and an elongate container for the conditioning component, in use the manifold head being sealingly assembled to an end of the container;
wherein the manifold head has an external wall, an inlet port for incoming flow of fluid into the column, an outlet port for outgoing flow of fluid out of the column, and an internal flow guidance formation for guiding the incoming flow to the conditioning component and for guiding the outgoing flow from the conditioning component, the flow guidance formation further maintaining separation of the incoming and outgoing flows within the column en route to and from the conditioning component; and
wherein the external wall and the internal flow guidance formation of the manifold head are constituent parts of a unitary extruded body section.

Advantageously, because extrusions are generally non-porous, the processes of porosity testing and post-testing corrective processing can be eliminated, yielding significant cost savings. A further advantage is that the quality of a machined surface finish that can be obtained from an extrusion is generally better than can be obtained from a casting. If the extrusion is formed e.g. of aluminium alloy, the inside and outside of the manifold head can also be anodized for corrosion protection, and optionally with a colouring finish.

Optional features of the first aspect of the invention will now be set out. These are applicable singly or in any combination.

The conditioning component can be e.g. a purifying component, a separating component (such as in gas generation applications), a heating component, or a cooling component. The fluid can be a gas, a liquid, or a gas liquid mixture.

Conveniently, the elongate container can be a tubular purification bowl. The container can also be formed from an extrusion.

The extruded body section may have radially spaced and substantially tubular outer and inner walls which are bridged by a bridging portion, the inner wall forming a central bore, the outer wall forming the external wall of the manifold head, and the inner wall and bridging portion forming the internal flow guidance formation. Thus the central bore can communicate with the centre of the conditioning component, and the space between the outer and inner walls can communicate with the exterior of the conditioning component. Conveniently the inlet and outlet ports can be formed in the tubular outer wall. For example, the inlet and outlet ports can be formed by machining respective passages in the outer wall, one of the passages passing through the outer wall to open to the truncated annular space formed between the outer and inner walls, and the other passage passing through the outer wall, bridging portion and inner wall to open to the central bore.

Typically, the unitary extruded body section has an extrusion direction which, when the manifold head is assembled to the container, is parallel with the axis of the column. The centre lines of the inlet and outlet ports may be perpendicular to the extrusion direction.

The inlet and outlet ports may be at diametrically opposed positions across the manifold head, although another option is for the inlet and outlet ports to be at 90° to each other around the manifold head. The manifold head can have multiple inlet and/or multiple outlet ports.

The manifold head may have a sealable connecting formation for removably assembling the manifold head to the end of the container, and many types of connecting formation are known in the art such as a screw thread or bayonet fixing. The connecting formation can be formed by machining the extruded body section.

The manifold head may be formed of extruded metal, such as aluminium alloy. Other options are to form the head from extruded magnesium alloy, titanium alloy, steel or plastic.

The manifold head may have a sealing cap to seal the side of the extruded body section distal from the container. For example, the sealing cap can seal the above-mentioned space between the outer and inner walls and central bore at the distal side.

Another option, however, is to connect two containers to opposite sides of the manifold head, thereby doubling the conditioning capacity at the head.

Accordingly, in a second aspect, the present invention provides a pair of fluid conditioning columns which each includes an elongate container which in use contains a respective conditioning component such that fluid can be conditioned by flow through the conditioning component, the pair of columns further having a shared manifold head of the first aspect (which may have any of the optional features of the first aspect, whether singly or in any combination) sealingly assembled to ends of the columns;
wherein the containers are at opposite sides of the extruded body section such that the columns share the external wall, inlet port, outlet port, and internal flow guidance formation of the manifold head.

Another option is to provide a multi-manifold head for a multi-column arrangement, in which two or more, typically side-by-side, columns share the same multi-manifold head.

Accordingly, in a third aspect, the present invention provides a multi-manifold head for a plurality of columns in each of which fluid is conditioned by flow through a respective conditioning component, the multi-manifold head incorporating a plurality of the manifold heads according to the first aspect (which may have any of the optional features of the first aspect, whether singly or in any combination) such that each manifold head is, in use, sealingly assembled to an end of a respective container, and each manifold head has a respective external wall, inlet port, outlet port, and internal flow guidance formation;
wherein the extruded body sections of the manifold heads are constituent parts of an over-arching unitary extruded body section.

Advantageously, multi-manifold head allow the possibility of employing a single set-up for machining, thus cutting down on machining costs relative to machining individual manifold heads. Multi-manifold head can also cut down on potential leak paths when building multi column combinations. This can be particularly significant for gas generation and other critical systems where any loss of valuable product should be minimised and/or may pose a safety concern.

Optional features of the third aspect of the invention will now be set out. These are applicable singly or in any combination.

The inlet and outlet ports may be arranged such that there is no fluid flow from one column to another. Preferably, however, the ports are arranged so that the outlet port of one column directs fluid to the inlet port of a neighbouring column. The columns can thus condition the fluid in series.

For example, when each manifold head has the radially spaced and substantially tubular outer and inner walls which are bridged by the bridging portion, and the inlet and outlet ports of that column are formed by machining the respective passages, then, as between neighbouring columns, the passage forming the outlet port for one column may be shared by the neighbouring column such that it forms the inlet port for the neighbouring column. In this case, one or more additional machined passages may be formed in the over-arching extruded body section to provide machine access to form the or each shared passage, the additional machined passage(s) being closed by respective plugs.

In a fourth aspect, the present invention provides a fluid conditioning column including:
an elongate container which in use contains a conditioning component such that fluid can be conditioned by flow through the conditioning component; and
a manifold head according to the first aspect (which may have any of the optional features of the first aspect, whether singly or in any combination) which is sealingly assembled to an end of the container.

In a fifth aspect, the present invention provides a plurality of fluid conditioning columns which each includes an elongate container which in use contains a respective conditioning component such that fluid can be conditioned by flow through the conditioning component, the plurality of conditioning columns further having the multi-manifold head according to the third aspect (which may have any of the optional features of the third aspect, whether singly or in any combination) sealingly assembled to the ends of the containers.

In a sixth aspect, the present invention provides a method of producing the manifold head of the first aspect (which may have any of the optional features of the first aspect, whether singly or in any combination) including:
providing a unitary extruded body section having the external wall and the internal flow guidance formation; and
machining the extruded body section to form the inlet port and the outlet port.

In a seventh aspect, the present invention provides a method of producing the multi-manifold head of the third aspect (which may have any of the optional features of the third aspect, whether singly or in any combination) including:
providing an over-arching unitary extruded body section having the external walls and the internal flow guidance formations; and
machining the over-arching extruded body section to form the inlet ports and the outlet ports.

The method of sixth or seventh aspect may further include preliminary steps of: extruding and sectioning a body to form the extruded body section.

### BRIEF DESCRIPTION OF THE SEVERAL VIEWS OF THE DRAWINGS

Embodiments of the invention will now be described by way of example with reference to the accompanying drawings in which:

For example FIG. 1 is a front view partly in vertical section of a filter column of known type;

FIG. 2 shows a transverse section through such an extruded body section;

FIG. 3 shows a longitudinal section on plane A-A of FIG. 2;

FIG. 4 show a corresponding section that of FIG. 2, but after machining of the extruded body section to form a manifold head;

FIG. 5 show a corresponding section that of FIG. 3, but after machining of the extruded body section to form the manifold head;

FIG. 6 shows a close up view of a port of the manifold head of FIGS. 4 and 5, the port having optional joining and sealing features;

FIG. 7 shows a close up view of a mounting bracket slot incorporated into a multi-manifold head;

FIG. 8 shows the manifold head on the section of FIG. 5, but further machined for assembling to a filter bowl and a sealing cap; and

FIG. 9 shows a transverse section through a unitary extruded body section which can be used to make two permanently connected manifold heads for two side-by-side columns, the extruded body section (a) being in the as-extruded state, (b) having passages machined therein for the formation of ports, and (c) having one of the passages plugged to prevent a flow short-circuit.

### DETAILED DESCRIPTION OF THE INVENTION

The present invention provides a manifold head for a conditioning column formed from a unitary extruded body section. In the following we refer to a column having an elongate container in the form of a tubular filter bowl for containing a filter element. However, the column can have an elongate container containing other types of conditioning component such as separators, fluid heaters, fluid coolers etc.

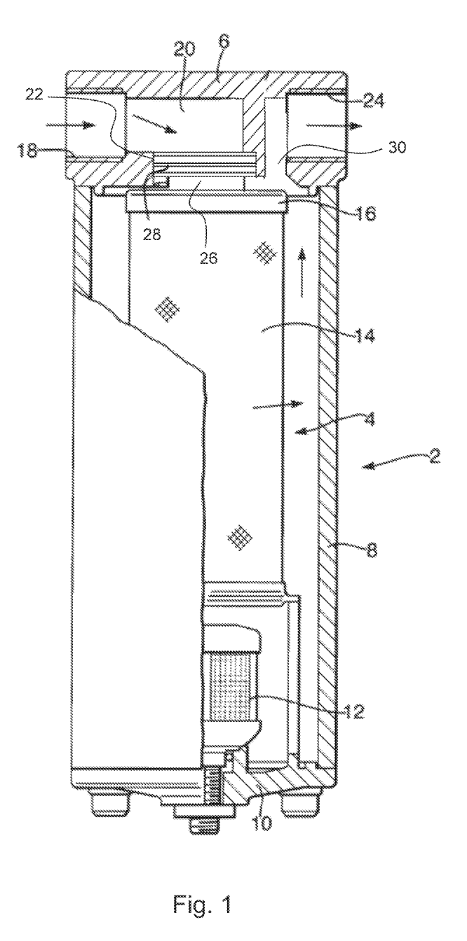

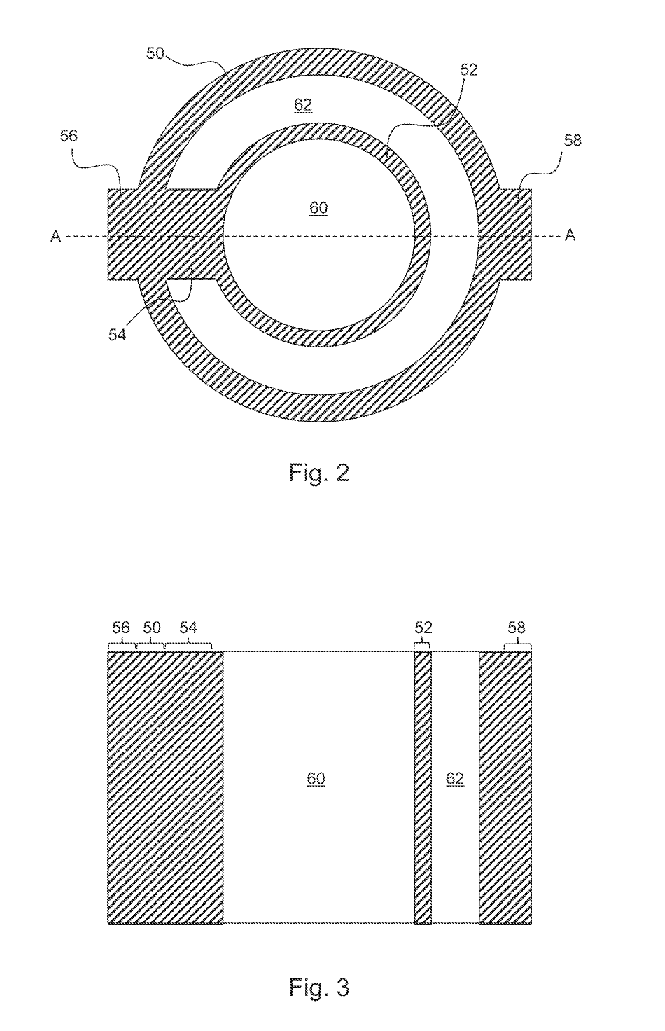

FIG. 2 shows a transverse section through such an extruded body section, which may typically be formed of aluminium alloy, and FIG. 3 shows a longitudinal section on plane A-A of FIG. 2. The extruded body section is formed by cutting lengths from a longer extrudate. The extrusion direction is perpendicular to the plane of the section in FIG. 2 and in the vertical direction in the section of FIG. 3.

The extruded body section has “tube-in-tube” configuration comprising radially spaced, outer 50 and inner 52 tubular walls. These are bridged by abridging portion 54 at one sector of the walls. A first protrusion 56 projects from the outer wall 50 at the other side of the wall to the bridging portion 54, and a second protrusion 58 projects from the outer wall 50 at a diametrically opposed position. A central bore 60 is formed by the inner wall 52 and a truncated annular space 62 is formed between the outer 50 and inner 52 walls.

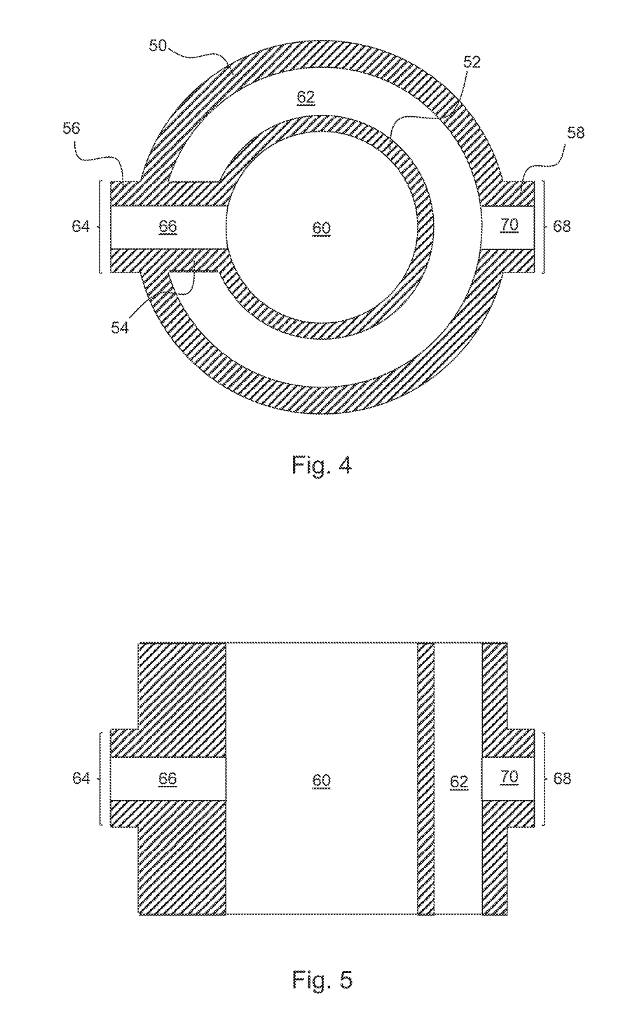

FIGS. 4 and 5 shows corresponding sections to those of FIGS. 2 and 3, but after machining of the extruded body section to form the manifold head. In particular, a first port 64 is formed by machining a first passage 66 through the first protrusion 56, outer wall 50, bridging portion 54 and inner wall 52 to open to the central bore 60. A second port 68 is formed by machining a second passage 70 through the second protrusion 58 and the outer wall 50 to the truncated annular space 62. Depending on the direction of flow through the column, the first port can be the inlet port and the second port the outlet port, or vice versa.

The first 56 and second 58 protrusions are also machined to leave a ring or square of projecting material around the respective port 64, 68. This can facilitate the connection of the ports to associated pipework. Other options are to leave the protrusions un-machined, or to mill slots in the protrusions to accept wedge connectors.

Advantageously, the manifold head formed from a unitary extruded body section can have improved pressure-tightness relative to a cast head as extrusions are generally free of porosity. Further, extrusions can provide a good machined finish. Aluminium alloy extrusions can also be anodized.

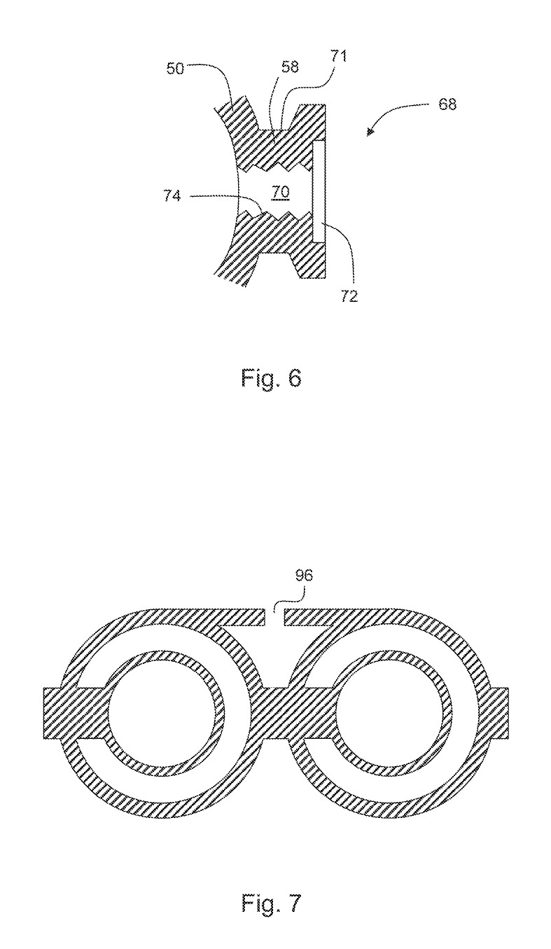

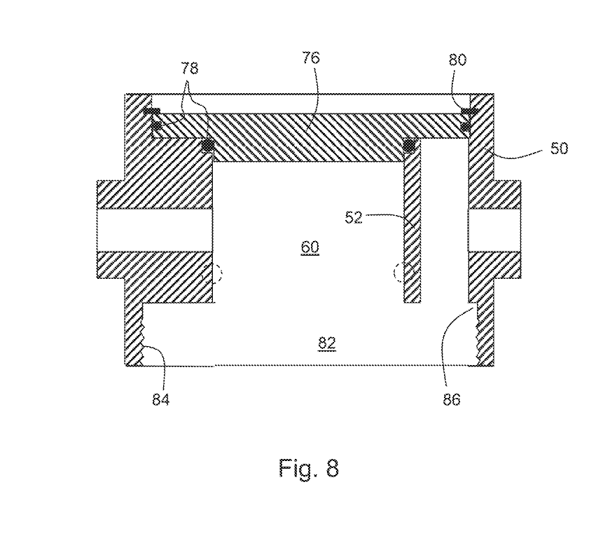

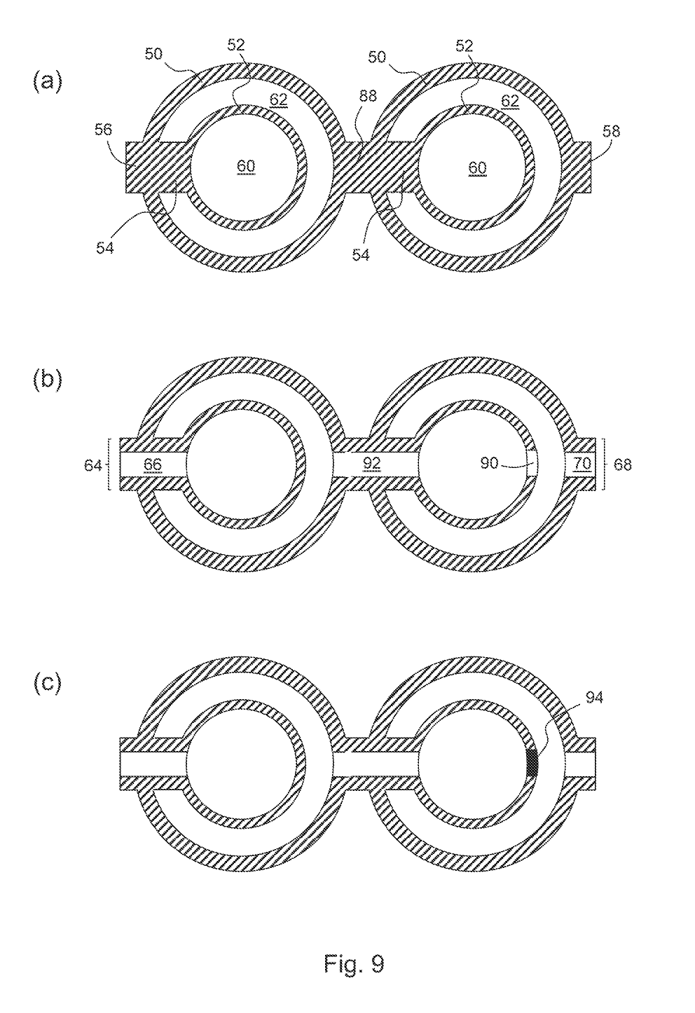

The extruded body section can be readily adapted to provide the manifold head with further or different features. For example:
The first 56 and second 58 protrusions can be eliminated so that the mouths of the ports 64, 68 are flush with the external surface of the outer all 50.
Additional material can be incorporated into the extrusion, e.g. at the inner surface of the outer wall adjacent the second port 70, providing greater depth of material for a pipe threads.
The ports 64, 68 can be located at different relative positions around the manifold head, and/or can be machined at different angles relative to the axis of the column.
Flanges can be machined or slots 71 to accept wedge connectors can be readily incorporated into the outer wall of the extrusion around the mouths of the ports 64, 68 to facilitate fixing to adjacent pipework or to connect additional units, as shown in FIG. 6.
Spot faces 72 can be machined at the mouths of the ports 64, 68 to facilitate location of sealing gaskets, as also shown in FIG. 6.
Internal 74 or external joining threads can be machined on each port, as also shown in FIG. 6.
Features, such as a mounting bracket slot 96 shown in FIG. 7, can be readily incorporated (the extrusion in this case is for a multi-manifold head, described below in more detail in relation to FIG. 9).

FIG. 8 shows the manifold head on the section of FIG. 5, but further machined for assembling to a filter bowl, and a sealing cap in the form of a pressure retaining plug 76.

More particularly, one end of the head is machined to provide a recess for the plug, which is sealed to inner surfaces of the outer 50 and inner 52 walls by O-rings 78, and held in place with a circlip 80.

At the other end of the head, a further recess 82 is formed extending radially to a threaded region 84 formed in the inner surface of the outer wall 50. The filter bowl of the column can then be threadingly attached to manifold head at this region, a further region 86 being formed in the inner surface of the outer wall 50 above the threaded region 84 to accommodate a sealing element, such an O-ring, for sealing the bowl to the head. Another option, however, is to sealingly assemble filter bowls at both sides of the head, thereby doubling the head's flow filtering capacity. This can be achieved by machining filter bowl recesses at both ends of the head, rather than a plug recess at one end and a filter bowl recess at the other.

The outer wall 50 is the pressure envelope of the manifold head. The inner wall 52, on the other hand, is used to attach to the conditioning component. This can be achieved, for example, by providing a conduit projecting upwards into the central bore 60 from an end cap of the filter element component, the conduit being sealed to the internal surface of the inner wall 52 by one or more O-rings, e.g. at the position indicated by dashed circles in FIG. 8.

The concept of forming a manifold head from an extruded body section can be extended to form a multi-manifold head for a plurality of columns. Although discussed below in the context of a bi-manifold head, multi-manifold heads can be produced for three or four or more columns.

FIG. 9(a) shows, by way of example, a transverse section through a unitary extruded body section which can be used to make two permanently connected manifold heads for two side-by-side columns. The extruded body section over-archingly combines the features of two extruded body sections of the example of FIGS. 2 to 8. As discussed in more detail below, the multi-manifold head allows the outlet port of one column to feed directly and permanently into the inlet port of the other column so that fluid can pass through the columns in series for sequential conditioning. Purely by way of example, the upstream manifold head can be used with a column which removes liquid and particulate from compressed air, and the downstream head can be used with a column which contains a heater for heating the filtered air. Advantageously, permanently connected manifold heads have fewer potential leak paths than non-permanently connected heads.

In FIG. 9(a), reference numbers are given to features of the extruded body section according to the reference numbers given to equivalent features of FIG. 2. Thus both left and right hand halves of the extruded body section, corresponding to left and right manifold heads, have outer 50 and inner 52 tubular walls, a bridging portion 54, a central bore 60 and a truncated annular space 62. The left hand manifold head also has a first protrusion 56 and the right hand manifold head has a second protrusion 58. However, in place of further first and second protrusions, a common linking portion 88 permanently joins the two heads.

As shown in FIG. 9(b), the left hand manifold head is provided with a first port 64 by machining a first passage 66 through the first protrusion 56, outer wall 50, bridging portion 54 and inner wall 52 of that head. Similarly, the right hand manifold head is provided with a second port 68 by machining a second passage 70 through the second protrusion 58 and outer wall 50 of that head.

Using the second passage 70 as access, third 90 and fourth 92 passages in-line with the second passage are also machined. The third passage 90 passes through the inner wall 52 of the right hand head, while the fourth passage 92 passes through the inner wall 52, bridging portion 54 and outer wall 50 of the right hand head, the linking portion 88, and the outer wall 50 of the left hand head. The fourth passage 92 thus connects the truncated annular space 62 of the left hand head to the central bore 60 of the right hand head, effectively creating and merging an outlet port of one head with an inlet port of the other head.

As shown in FIG. 9(c), the third passage 90 can then be closed with a plug 94 to prevent a flow short-circuit between the central bore 60 and the truncated annular space 62 of the right hand head.

Another option, which reduces the number of machining steps but introduces a further plugging step, is simply to machine a bore across the entire extruded body section in one operation, thereby creating the first to fourth passages 66, 70, 90, 92, and in addition creating a fifth passage in the inner wall of the left hand head. This fifth passage and the third passage 90 can be closed with respective plugs. Alternatively, the open passages can be sealed and/or plugged by the end cap of the conditioning element via the use of an angular sealing arrangement such as that described by GB A 2408223.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

I claim:

1. A manifold head for a column in which fluid is conditioned by flow through a conditioning component, the column including the manifold head and an elongate container for the conditioning component, in use the manifold head being sealingly assembled to an end of the container;
wherein the manifold head has an external wall, an inlet port for incoming flow of fluid into the column, an outlet port for outgoing flow of fluid out of the column, and an internal flow guidance formation for guiding the incoming flow to the conditioning component and for guiding the outgoing flow from the conditioning component, the flow guidance formation further maintaining separation of the incoming and outgoing flows within the column en route to and from the conditioning component;
wherein the external wall and the internal flow guidance formation of the manifold head are constituent parts of a unitary extruded body section; and
wherein the extruded body section has radially spaced and substantially tubular outer and inner walls which are bridged by a bridging portion, the inner wall forming a central bore, the outer wall forming the external wall of the manifold head, and the inner wall and bridging portion forming the internal flow guidance formation.

2. A manifold head according to claim 1, wherein the inlet and outlet ports are formed by machining respective passages in the outer wall, one of the passages passing through the outer wall to open to the truncated annular space formed between the outer and inner walls, and the other passage passing through the outer wall, bridging portion and inner wall to open to the central bore.

3. A manifold head according to claim 1, wherein the unitary extruded body section has an extrusion direction which, when the manifold head is assembled to the container, is parallel with the axis of the column.

4. A manifold head according to claim 3, wherein the centre lines of the inlet and outlet ports are perpendicular to the extrusion direction.

5. A manifold head according to claim 1, wherein the inlet and outlet ports are at diametrically opposed positions across the manifold head.

6. A manifold head according to claim 1 which has a sealable connecting formation for removably assembling the manifold head to the end of the container.

7. A manifold head according to claim 1 which is formed of extruded aluminium alloy.

8. A manifold head according to claim 1 which has a sealing cap to seal the side of the extruded body section distal from the container.

9. A pair of fluid conditioning columns which each includes an elongate container which in use contains a respective conditioning component such that fluid can be conditioned by flow through the conditioning component, the pair of columns further having a shared manifold head according to claim 1 sealingly assembled to ends of the columns;
wherein the containers are at opposite sides of the extruded body section such that the columns share the external wall, inlet port, outlet port, and internal flow guidance formation of the manifold head.

10. A multi-manifold head for a plurality of columns in each of which fluid is conditioned by flow through a respective conditioning component, the multi-manifold head incorporating a plurality of the manifold heads according to claim 1 such that each manifold head is, in use, sealingly assembled to an end of a respective container, and each manifold head has a respective external wall, inlet port, outlet port, and internal flow guidance formation;
wherein the extruded body sections of the manifold heads are constituent parts of an over-arching unitary extruded body section.

11. A multi-manifold head according to claim 10, wherein the inlet and outlet ports are formed by machining respective passages in the outer wall, one of the passages passing through the outer wall to open to the truncated annular space formed between the outer and inner walls, and the other passage passing through the outer wall, bridging portion and inner wall to open to the central bore, such that each manifold head has the radially spaced and substantially tubular outer and inner walls which are bridged by the bridging portion, and the inlet and outlet ports of each manifold head are formed by machining the respective passages; and
wherein, as between neighbouring columns, the passage forming the outlet port for one column is shared by the neighbouring column such that it forms the inlet port for the neighbouring column.

12. A multi-manifold head according to claim 10, wherein one or more additional machined passages are formed in the over-arching extruded body section to provide machine access to form the or each shared passage, the additional machined passage(s) being closed by respective plugs.

13. A fluid conditioning column including:
an elongate container which in use contains a conditioning component such that fluid can be conditioned by flow through the conditioning component; and
a manifold head according to claim 1 which is sealingly assembled to an end of the container.

14. A plurality of fluid conditioning columns which each includes an elongate container which in use contains a respective conditioning component such that fluid can be conditioned by flow through the conditioning component, the plurality of conditioning columns further having a multi-manifold head according to claim 10 sealingly assembled to the ends of the containers.

15. A method of producing the manifold head of claim 1 including:
providing a unitary extruded body section having the external wall and the internal flow guidance formation; and
machining the extruded body section to form the inlet port and the outlet port.

16. A method of producing the multi-manifold head of claim 10 including:
providing an over-arching unitary extruded body section having the external walls and the internal flow guidance formations; and
machining the over-arching extruded body section to form the inlet ports and the outlet ports.
